(19) United States
(12) Patent Application Publication
(10) Pub. No.: US 2008/0250624 A1
(43) Pub. Date: Oct. 16, 2008

(54) METHOD FOR CONVERTING A TURBINE CASING

(75) Inventors: Wilfried Storch, Berlin (DE); Andreas Filert, Berlin (DE); Bernd Meixner, Walldorf (DE)

Correspondence Address: DARBY & DARBY P.C., P.O. BOX 770, Church Street Station, New York, NY, 10008-0770, US

(73) Assignee: ALSTOM Technology Ltd, Baden (CH)

(21) Appl. No.: 12/101,642

(22) Filed: Apr. 11, 2008

(30) Foreign Application Priority Data
Apr. 13, 2007 (DE) 10 2007 017 887.7

(51) Int. Cl. B23P 19/04

(52) U.S. Cl. 29/402.03

(57) ABSTRACT

A method for converting a turbine casing of a turbine having an axial flange relative to a rotational axis of a rotor of the turbine, and having a radial hot gas inlet relative to the rotational axis includes the steps of: axially separating the turbine casing into two axial sections so as to form a separation zone, wherein the first axial section has the flange and the second axial section has the hot gas inlet; rotating the two axial sections relative to each other around the rotational axis so as to transfer each of the two axial sections from an original old relative position into a new relative position; and connecting the two axial sections to each other in the new relative position along the separation zone.

Priority is claimed to German Patent Application No. DE 10 2007 017 887.7, filed on Apr. 13, 2007, the entire disclosure of which is incorporated by reference herein.

The present invention relates to a method for converting a turbine casing of a turbine, which has an axial flange in relation to a rotational axis of a rotor of the turbine and a radial hot gas inlet in relation to the rotational axis. The invention also relates to a turbine casing which in particular is converted by the aforementioned method. Furthermore, the invention relates to the use of a water-jet cutting process, and also the use of a laser welding process or of an electron welding process when converting a turbine casing.

### BACKGROUND

A conventional turbine casing of a turbine, especially of a gas turbine, customarily comprises two half-shells, specifically an upper shell and a lower shell, which abut along a parting plane in which lies the rotational axis of the rotor of the turbomachine, and are fastened to each other via a corresponding flange connection. The half-shells in this case are customarily cast parts in each case. The turbine casing has an axial flange by which the turbine casing can be connected to another component of the turbomachine. For example, the flange forms virtually an outlet for the expanded hot operating gas of the turbine. The flange comprises two halves which in each case are an integral component part of the respective half-shell of the turbine casing. Furthermore, the turbine casing has a radial hot gas inlet via which hot and compressed operating gas, which during operation of the turbomachine comes from a combustion chamber, is fed to the turbine which is arranged inside the turbine casing. This hot gas inlet in this case is formed on one of the two half-shells.

With older turbomachines, the combustion chamber is a separate component in relation to the turbine and is arranged beside the turbine and at a distance to it. With this older type of construction, the hot operating gas which is produced by the combustion chamber is then fed from the bottom to the turbine casing via a supply line which is angled in the shape of a U. That is to say, with these turbomachines of earlier year of construction the hot gas inlet is formed on the lower shell of the turbine casing.

With more recent turbomachines, the combustion chamber is mounted directly on the turbine casing so that a supply line can be dispensed with. The hot gas inlet, therefore, with more recent turbomachines is located on the upper shell of the turbine casing. The arrangement of the more recent type of construction is characterized by reduced flow resistances and reduced temperature losses, which increases the efficiency of the turbomachine.

The operators of power generating plants constantly endeavor to implement newer and proven technologies, even in the case of older plants. Therefore, the desire exists to convert older turbomachines, in which the hot gas inlet is arranged on the underside of the turbine casing, so that the combustion chambers can be mounted on the turbine casing at the top. Exchanging the older turbine casing, with hot gas inlet located at the bottom, for a new turbine casing with hot gas inlet located at the top, is out of the question in this case because the costs for it are too high. Rotating the old turbine casing in order to bring the hot gas inlet from bottom to top can also be ruled out in this case since the flange of the turbine casing is non-symmetrical, so that extremely costly adaptation measures would also be necessary here.

### SUMMARY OF THE INVENTION

An aspect of the present invention is to provide a way to simplify the conversion of a turbine casing from one constructional form, with hot gas inlet located at the bottom, into a constructional form with hot gas inlet located at the top.

According to the present invention the entire turbine casing is not rotated, but instead only an axial section having the hot gas inlet is rotated while an axial section having the flange is left in its original installed position. First, the turbine casing is axially separated into two axial sections, wherein the first axial section has the flange and the second axial section has the hot gas inlet. The separating in this case is carried out so that a separation zone is formed in the process, which in particular is rotationally symmetrically configured in relation to the rotational axis. The two axial sections can then be rotated around the rotational axis relative to each other until the desired new relative position is found in each case. The two axial sections in the new relative position can then be reconnected to each other along the separation zone. The proposed conversion method on the one hand enables the use of the original turbine casing, so that a new turbine casing is not required. On the other hand, the flange can remain in its original relative position, so that also in this case costly adaptation measures are unnecessary. The cost for the conversion, therefore, is comparatively low, and with regard to the efficiency improvement which is expected as a result of the conversion, is worth considering for economical reasons.

An embodiment in which separating of the turbine casing into the two axial sections is realized by means of a water-jet cutting process, is especially advantageous in this case. It has been shown that the water-jet cutting process on the one hand can be comparatively cost-effectively realized, and on the other hand manages with extremely low material removal. This is especially advantageous since the gap which results during the water-jet cutting has an extremely small gap width which simplifies an axial compensation during the subsequent connecting of the two axial sections. It has even been shown that such a small gap width lies within the axial tolerances of the turbomachine, so that the material loss which results during the water-jet cutting is not problematical. In principle, other cutting processes or separating processes are also conceivable, which, however, are not optimum for various reasons. For example, the casing can be sawn open. The material loss in the process, however, is so great that an axial compensation without any problem is no longer ensured. During separation welding or laser cutting, a structural change in the cast material of the turbine casing can occur, which negatively affects the strength of the turbine casing. A wire-guided electrical discharge process is also conceivable, which, however, in the case of the casing thicknesses which are to be separated here, which can be in excess of 100 mm, is extremely costly and time-consuming.

For connecting the two axial sections which are rotated in relation to each other, a welding process is preferred, which manages without material addition. Material addition can lead to structural changes which negatively affects the stability of the turbine casing. Also, costly aftermachining measures can become necessary as a result of this. The use of a laser welding process or an electron beam welding process is especially advantageous. By such welding technologies, comparatively narrow separation gaps on their separation surfaces which face each other can be heated up to an extent that a fusion connection can be achieved.

Further important features and advantages of the invention result from the dependent claims, from the drawings, and from the associated figure description with reference to the drawing.

### BRIEF DESCRIPTION OF THE DRAWINGS

Preferred exemplary embodiments of the invention are shown in the drawings and are explained in more detail in the subsequent description, wherein like designations refer to the same, or similar, or functionally the same components. In the drawing, schematically in each case,

FIGS. 1 to 6 show a greatly simplified principal side view of a turbine casing during different phases of the conversion.

### DETAILED DESCRIPTION

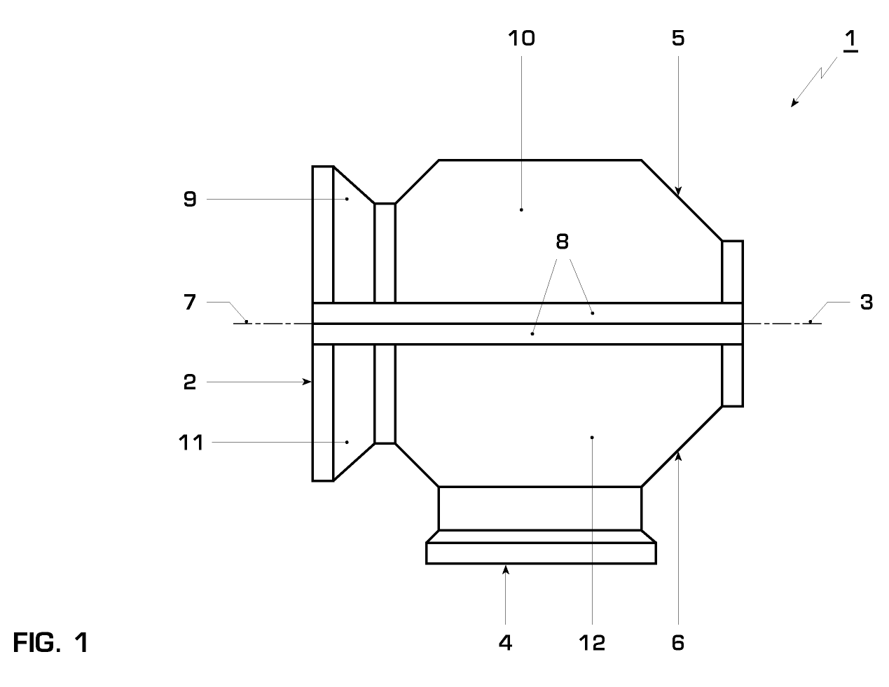

According to FIGS. 1 to 6, a turbine casing 1 of a turbomachine or of a turbine, which apart from that is not shown, comprises a flange 2, which is axially oriented in relation to a rotational axis 3 of a rotor, which is not shown here, of the turbine. In addition, the turbine casing 1 has a hot gas inlet 4 which is radially oriented in relation to the rotational axis 3. The turbine casing 1 has a basically conventional construction, and, therefore, is especially constructed from two half-shells, specifically from an upper shell 5 and a lower shell 6. The two half-shells 5, 6 abut along a parting plane 7, which is perpendicular to the plane of the drawing, and are fastened to each other in the region of the parting plane 7 via a flange connection 8. The half-shells 5, 6 are designed in each case as one-piece cast parts. The upper shell 5 integrally has an upper half 9 of the flange 2, and an upper half 10 of the remaining casing section. Similarly to this, the lower shell 6 integrally comprises a lower half 11 of the flange 2, and also a lower half 12 of the remaining casing section. The lower casing section half 12 also has the hot gas inlet 4. This is especially also an integral component part of the lower shell 6.

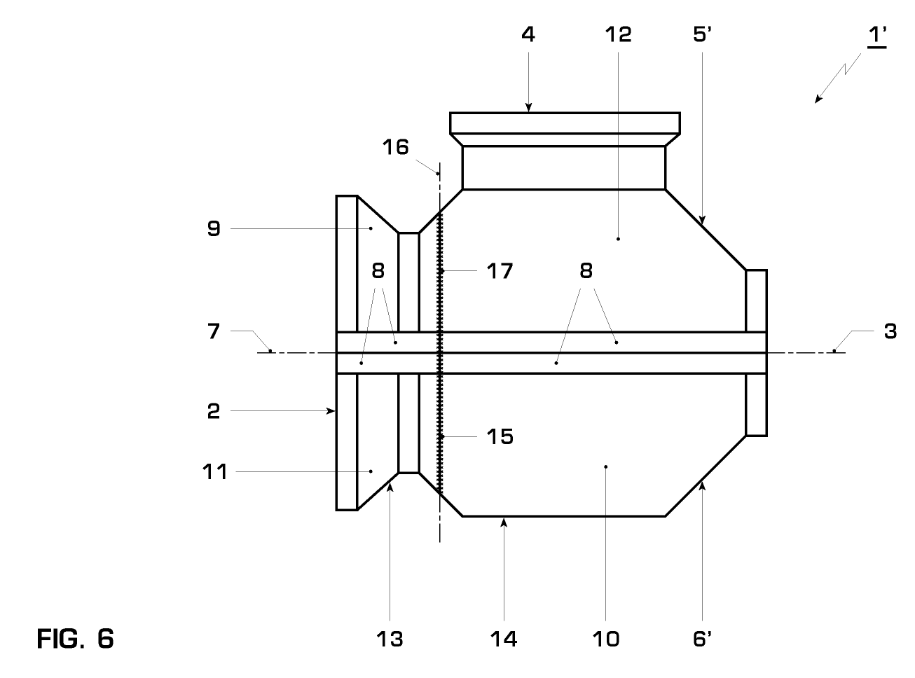

FIG. 1 shows the turbine casing 1 in an old state, that is before a conversion, which is described in more detail in the following. In this old state, the hot gas inlet 4 is arranged at the bottom, that is to say on the old lower shell 6. The old upper shell 5 is detachably fastened on the old lower shell 6 via the flange connection 4. The method according to the invention for converting the old turbine casing 1 into a new turbine casing 1′ which is shown in FIG. 6, proceeds as follows:

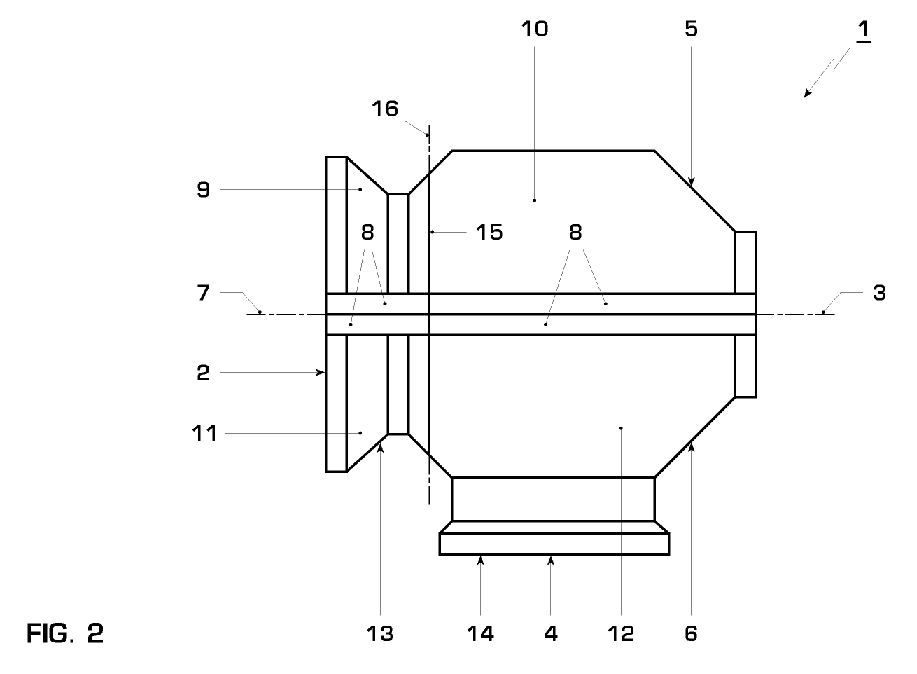

According to FIG. 2, first of all the old turbine casing 1 is axially separated into two axial sections, specifically into a first axial section 13 and a second axial section 14. The separating in this case is carried out so that a separation zone 15 is formed which is rotationally symmetrical in relation to the rotational axis 3. This separation zone 15 in this case can preferably lie in a separation plane 16 which extends transversely to the rotational axis 3. Alternatively, for example a separation zone 15 which extends along a generated surface of a truncated cone, which extends coaxially to the rotational axis 3, is also conceivable. The separating of the turbine casing 1 in this case is specifically realized so that the first axial section 13 then has the flange 2, while the second axial section 14 has the hot gas inlet 4.

The separating of the turbine casing 1 into the two axial sections 13, 14 is preferably realized by a waterjet cutting process. During the waterjet cutting, a separating cut, with which comparatively little material is removed, can be realized even in the case of relatively large wall thicknesses, as are customary with turbine casings 1. For example, by means of the waterjet cutting a gap which is in the range of 1 to 2 mm can be generated, even with wall thicknesses of more than 100 mm. With water-jet cutting, it is also especially advantageous that it is comparatively simply adaptable to different geometries and wall thicknesses of the turbine casing 1.

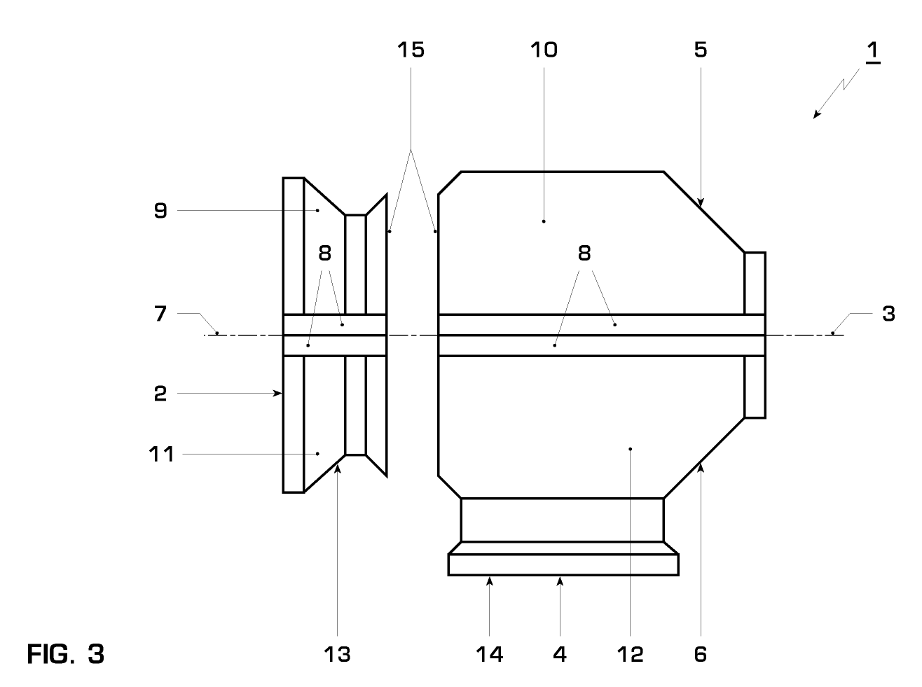

After separating the turbine casing 1 into the two axial sections 13, 14, these can be moved in relation to each other in the axial direction in accordance with FIG. 3. The first axial section 13, which has the flange 2, in FIG. 3 is positioned at an axial distance to the second axial section 14, which has the hot gas inlet 4.

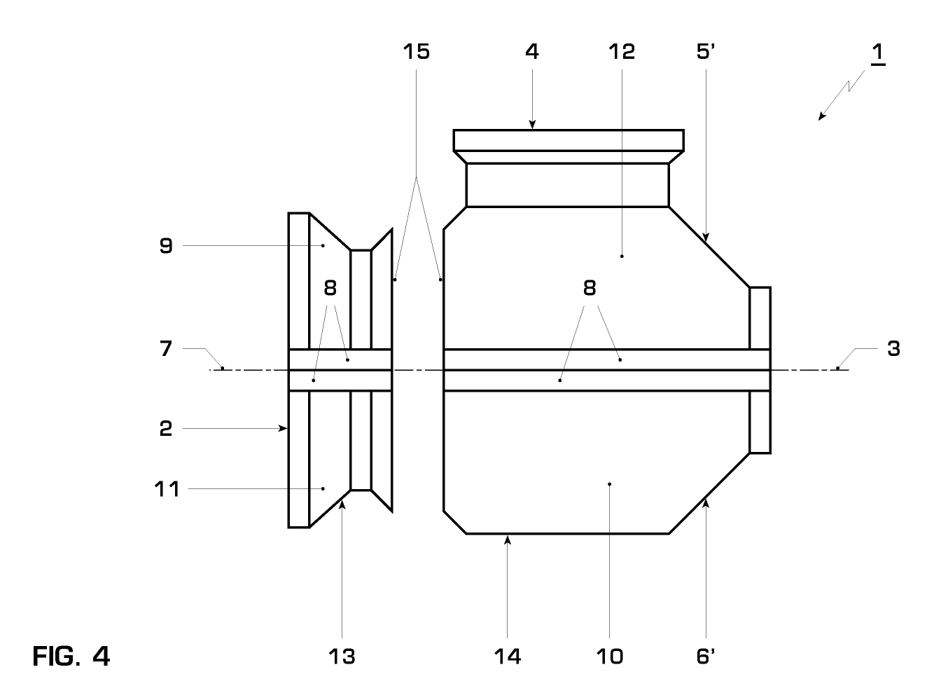

According to FIG. 4, the two axial sections 13, 14 can now also be rotated relative to each other around the rotational axis 3. With the preferred example of the conversion method which is shown here, a rotation by 180° is carried out. Accordingly, from the state shown in FIG. 4 onwards the hot gas inlet 4 is arranged at the top of the second axial section 14, whereas up until the state shown in FIG. 3 it is still arranged at the bottom of the second axial section 14 or at the bottom of the turbine casing 1. In principle, other angles of rotation are also conceivable. In FIGS. 1 to 3, the two axial sections 13, 14 (such as they are) have an old relative position in relation to each other. Contrary to this, the two axial sections 13, 14 in FIGS. 4 to 6 have a new relative position in relation to each other.

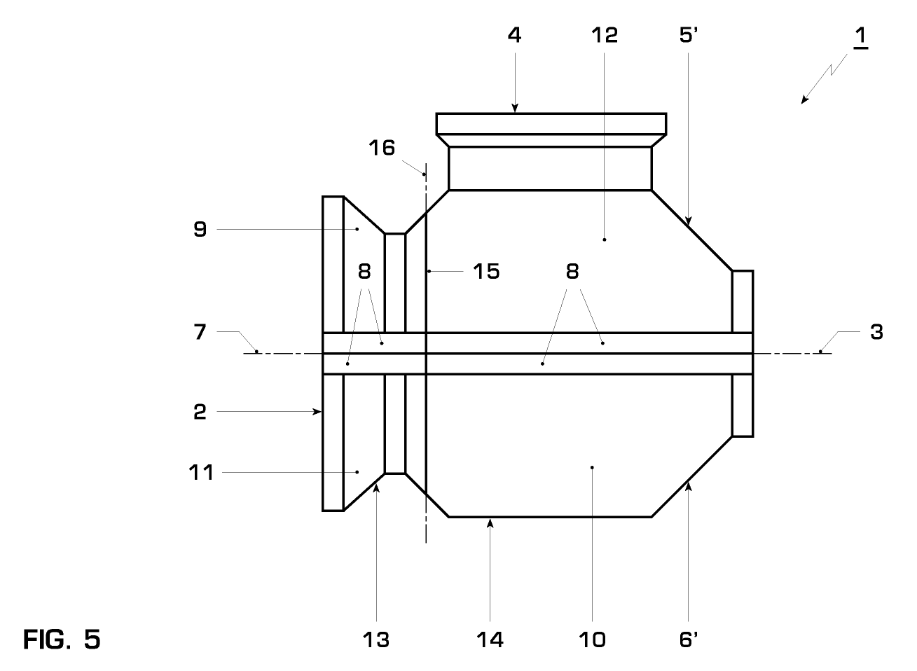

After rotating the two axial sections 13, 14 in relation to each other around the rotational axis 3, the two axial sections 13, 14 are again moved axially relative to each other until they again axially abut in the region of the separation zone 15 according to FIG. 5, or at least until they abut save for a gap which is required for the respective connecting technology. This can be readily realized since the separation zone 15 is rotationally symmetrically formed in relation to the rotational axis 3.

The two axial sections are then connected to each other along the separation zone 15 according to FIG. 6. For this purpose, a welded connection 17, which is indicated by a cross-hatching in FIG. 6, is suitable in a special way. A welding process which functions without material addition, that is to say which especially manages without wearing or melting electrodes, is preferred as a welding process in this case. A laser welding process or an electron beam welding process can be especially advantageously used in this case. Such welding processes are suitable in a special way for connecting metallic components, in the case of narrow gap sizes, without material addition.

FIG. 6 now shows the converted or new turbine casing 1′ which has a new upper shell 5′ and a new lower shell 6′. The new upper shell 5′, after assembling the two axial sections 13, 14, comprises the upper flange half 9 and the lower casing section half 12 which has the hot gas inlet 4. Contrary to this, the new lower shell 6′ comprises the lower flange half 11 and the upper casing section half 10. As with the original old turbine casing 1, with the new turbine casing 1′ the two new half shells 5′, 6′ also abut along the parting plane 7 and are detachably fastened to each other via the flange connection 8.

After connecting the two axial sections 13, 14, another thermal aftertreatment of the new turbine casing 1′ can be carried out, at least in the region of the welded connection 17, for example in order to relieve stresses in the structure.

It is clear that it is not necessary to separate the entire turbine casing 1 in the described manner into the two axial sections 13, 14 and then to fasten the two axial sections 13, 14 to each other again with a changed rotational position. In particular, it is possible to separate the two old half-shells 5, 6 independently of each other. The flange halves 9, 11 can also be additionally or alternatively individually attached to the associated casing section halves 10, 12 of the respective new half-shell 5′, 6′.

What is claimed is:

1. A method for converting a turbine casing of a turbine having an axial flange relative to a rotational axis of a rotor of the turbine, and having a radial hot gas inlet relative to the rotational axis, the method comprising:
axially separating the turbine casing into two axial sections so as to form a separation zone, wherein the first axial section has the flange and the second axial section has the hot gas inlet;
rotating the two axial sections relative to each other around the rotational axis so as to transfer each of the two axial sections from an original old relative position into a new relative position; and
connecting the two axial sections to each other in the new relative position along the separation zone.

2. The method as recited in claim 1, wherein the separating is performed by waterjet cutting.

3. The method as recited in claim 1, wherein the separating is performed so that the separation zone is formed to be rotationally symmetrical relative to the rotational axis.

4. The method as recited in claim 1, wherein the separating is performed so that the separation zone lies in a separation plane extending perpendicularly to the rotational axis.

5. The method as recited in claim 1, wherein the rotating is performed so that the two axial sections are rotated around the rotational axis by 180° relative to each other.

6. The method as recited in claim 1, wherein the connecting of the two axial sections is performed using a welding process that functions without material addition.

7. The method as recited in claim 1, wherein the connecting of the two axial sections is performed using at least one of a laser welding process and an electron beam welding process.

8. The method as recited in claim 1, wherein, prior to the axially separating, rotating, and connecting, the turbine casing has an old upper shell an and old lower shell abutting each other along a parting plane and being detachably fastened to each other via a flange connection, wherein the old upper shell is a cast part integrally including an upper half of the flange and an upper half of a remaining casing section and wherein the old lower shell is a cast part integrally including a lower half of the flange, and a lower half of the remaining casing section having the hot gas inlet; and
wherein, after the separating, rotating and connecting, the turbine casing has a new upper shell and a new lower shell abutting each other along the parting plane and being detachably fastened to each other via the flange connection, wherein the new upper shell has the upper flange half and the lower casing section half, and wherein the new lower shell has the lower flange half and the upper casing section half.

9. A method for separating a turbine casing of a turbine having an axial flange relative to a rotational axis of a rotor of the turbine, and having a radial hot gas inlet relative to the rotational axis, the method comprising:
axially separating the turbine casing into two axial sections using a waterjet cutting process so as to form a separation zone, wherein the first axial section has the flange and the second axial section has the hot gas inlet.

10. A method for connecting first and second axial sections of a turbine casing of a turbine, the first axial section having an axial flange and the second axial section having a radial hot gas inlet, the method comprising:
connecting the first axial section to the second axial section using laser welding.
